(19) United States
(12) Patent Application Publication
(10) Pub. No.: US 2018/0203229 A1
(43) Pub. Date: Jul. 19, 2018

(54) SEE-THROUGH EYEPIECE FOR NEAR-EYE DISPLAY

(71) Applicant: JORJIN TECHNOLOGIES INC., New Taipei City (TW)

(72) Inventors: Chun Wei Lu, New Taipei City (TW); Shiann Jang Wang, New Taipei City (TW); Wen-Lung Liang, New Taipei City (TW)

(21) Appl. No.: 15/405,312

(22) Filed: Jan. 13, 2017

(51) Int. Cl. G02B 27/01; G02B 5/04; G02B 27/14; G02B 5/10

(52) U.S. Cl. CPC G02B 27/0172; G02B 5/04; G02B 27/144; G02B 2027/015; G02B 2027/0123; G02B 2027/011; G02B 5/10

(57) ABSTRACT

The see-through eyepiece includes a first prism, a second prism, and a partially reflective layer. The first prism has an input surface, a flat first total internal reflection surface, and a first interface surface. The second prism has a second interface surface, a flat second total internal reflection surface, and a reflection surface. The partially reflective layer is disposed between the second interface surface and the first interface surface. The second and first prisms are attached together along the second and first interface surfaces, thereby forming the complete see-through eyepiece. The present invention is able to reduce the traversal distance of light within the prisms, effectively lowering the thickness of the see-through eyepiece, or enhancing its field or angle of view. A user may perceive images more easily and conveniently, achieving better product performance and applicability.

### BACKGROUND OF THE INVENTION

### (a) Technical Field of the Invention

The present invention is generally related to optical techniques, and more particular to a see-through eyepiece for near eye display.

### (b) Description of the Prior Art

Near Eye Display (NED) or Head Mount Display (HMD), or Head Wearable Display is a display device worn on or around a user's head. Some of these NEDs or HMDs are equipped with a see-through eyepiece superimposing external scene with artificial images. These devices have a great potential in transportation (e.g., for providing information to drivers or pilots) or entertainment. They can also be utilized in the popular Augmented Reality (AR). Existing see-through eyepieces such as those taught by US2013070338A1 and US2015177519A1 mainly integrate a microdisplay device and a light guide component made of a transparent material such as glass or plastics. When image (light) of the microdisplay device enters the light guide component at an angle, it undergoes optical reflection so that the user's eye may perceive or receive the image from another angle of surface of the light guide component. In the meantime, the user may also see external scene through the transparent light guide component. The thickness of the light guide component (measured from a side of the light guide component facing user's eye to another side of the light guide component facing external scene) is rather thick and the field of view (FOV) or angle of view (AOV) is limited. Therefore the see-through eyepieces are heavier and the user experiences more difficulty and inconvenience in perceiving images.

There are teachings utilizing freeform optics in designing the light guide component. This technique may enhance FOV or AOV but inevitably would lead to distortion of the image or external scene. This distortion may be improved or compensated through additional optical mechanism, but the design complexity and cost are increased as well, significantly affecting the applicability of the see-through eyepiece.

### SUMMARY OF THE INVENTION

Therefore, to obviate the above shortcomings, a major objective of the present invention is to provide a see-through eyepiece of reduced thickness or enhanced angle of view.

To achieve the objective, the see-through eyepiece includes a first prism, a second prism, and a partially reflective layer. The first prism has an input surface for receiving light from a display device in entering the first prism, a flat first total internal reflection surface, and a first interface surface. The second prism has a second interface surface, a flat second total internal reflection surface, and a reflection surface coated with a reflection layer. The partially reflective layer is disposed between the second interface surface of the second prism and the first interface surface of the first prism. The second and first prisms are attached together along the second and first interface surfaces, thereby forming the complete see-through eyepiece with the first total internal reflection surface and the second total internal reflection surface positioned in parallel on two opposite sides of the see-through eyepiece, and the input surface and the reflection surface also positioned in parallel on another two opposite sides of the see-through eyepiece.

The input surface is a curved or aspheric surface carved with binary diffi active optical elements (DOEs). The reflection surface is a curved or aspheric surface.

The partially reflective layer is a beam splitter.

The reflection layer is an aluminum or silver layer.

The angle of inclination θ of the partially reflective layer satisfies the conditions: θ≥(θ_{c}+θ′)/2, θ′=arcsin(sin α/n), and θ_{c}=arcsin(1/n), where θ′ is the refraction angle of light passing through the second total internal reflection surface from air, θ_{c} is the critical angle for total internal reflection, a is the half angle of view, n is the refractive index of the second prism.

The present invention is able to reduce the traversal distance of light within the prisms, effectively lowering the thickness of the see-through eyepiece, or enhancing its field or angle of view. A user may perceive images more easily and conveniently, achieving better product performance and applicability.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing a see-through eyepiece according to an embodiment of the present invention.

FIG. 2 is a perspective schematic diagram showing the see-through eyepiece of FIG. 1 after assembly.

FIG. 3 is a schematic side-view diagram showing the see-through eyepiece of FIG. 1.

FIG. 3A is a schematic diagram showing the relationship between the half angle of view and the angle of inclination of a partially reflective layer of the see-through eyepiece of FIG. 1.

FIG. 4 is a schematic diagram showing trajectory of light from a display device as the light passes through the see-through eyepiece of FIG. 1.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

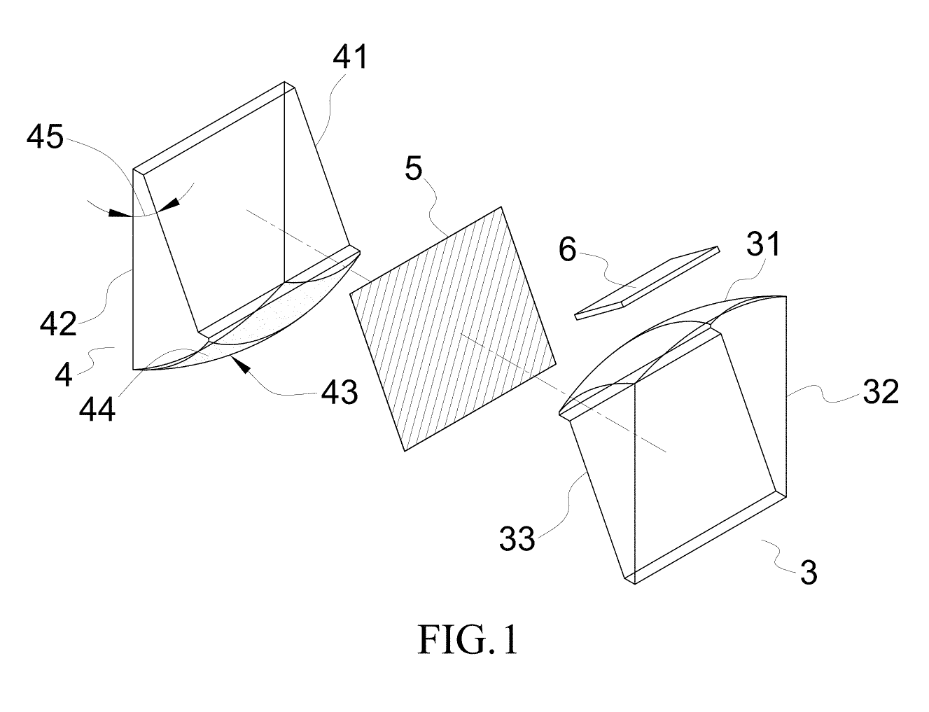

As shown in FIGS. 1 to 3, a see-through eyepiece according to an embodiment of the present invention includes a first prism 3, a second prism 4, and a partially reflective layer 5.

The first and second prisms 3 and 4 are made of glass or optical grade plastics. The present embodiment preferably uses optical grade plastics due to its light weight. The first prism 3 has a curved or aspheric input surface 31 usually carved with binary diffi active optical elements (DOEs) for eliminating chromatic difference of magnification. The detailed structure of DOEs should be familiar to those of related art and is not the focus of the present invention. Therefore the DOEs are not shown in the drawings and their description is omitted here. The input surface 31 is for receiving light from a display device 6 in entering the first prism 3. The display device 6 may be a Liquid Crystal on Silicon (LCoS) display device or an Organic Light Emitting Diode (OLED) display device. In the present embodiment, the display device 6 is preferably an OLED display device which does not require a backlight module and therefore achieves space efficiency. Additionally, the first prism 3 has a flat (i.e., planar and non-curved) first total internal reflection surface 32 and a first interface surface 33.

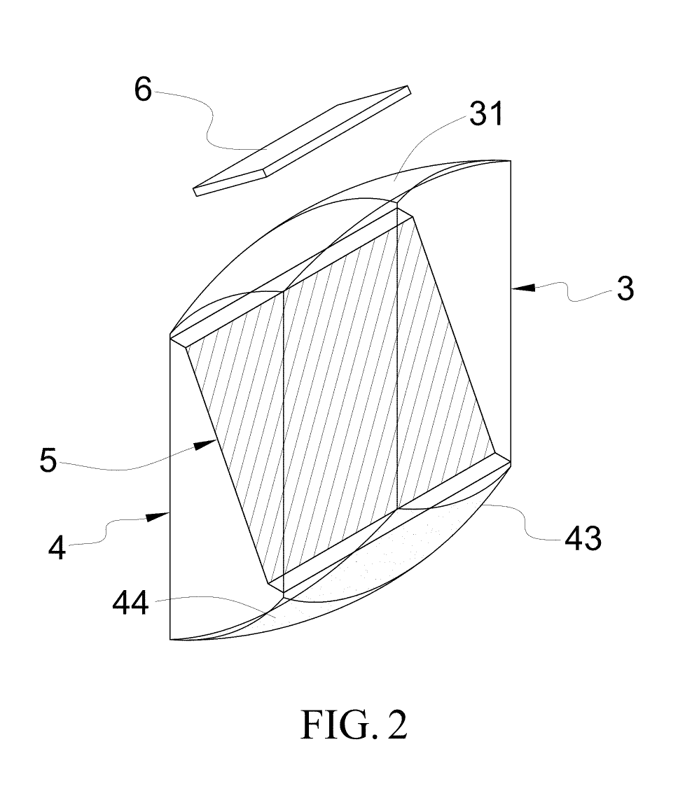

The second prism 4 has a second interface surface 41, a flat second total internal reflection surface 42, and a curved or aspheric reflection surface 43. The reflection surface 43 is coated with a reflection layer 44 so as to function as a curved mirror or, more specifically, a concave mirror. The reflection layer 44 may be an aluminum or silver layer. The partially reflective layer 5 is disposed between the second interface surface 41 of the second prism 4 and the first interface surface 33 of the first prism 3. The second and first prisms 4 and 3 are attached together along the second and first interface surfaces 41 and 33, thereby forming the complete see-through eyepiece with the first total internal reflection surface 32 and the second total internal reflection surface 42 oppositely positioned and in parallel, and the input surface 31 and the reflection surface 43 also oppositely positioned. For example, as shown in FIGS. 1 and 2, the first total internal reflection surface 32 and the second total internal reflection surface 42 are at a front side and a back side of the see-through eyepiece, respectively, and the input surface 31 and the reflection surface 43 are at a top side and a bottom side of the see-through eyepiece, respectively. It should be noted that the second total internal reflection surface 42 is at the side of the see-through eyepiece that faces a user's eye whereas the first total internal reflection surface 32 is at the side of the see-through eyepiece that faces an external scene.

Specifically, the partially reflective layer 5 may be a conventional beam splitter such as a non-polarized beam splitter or a polarized beam splitter (PBS).

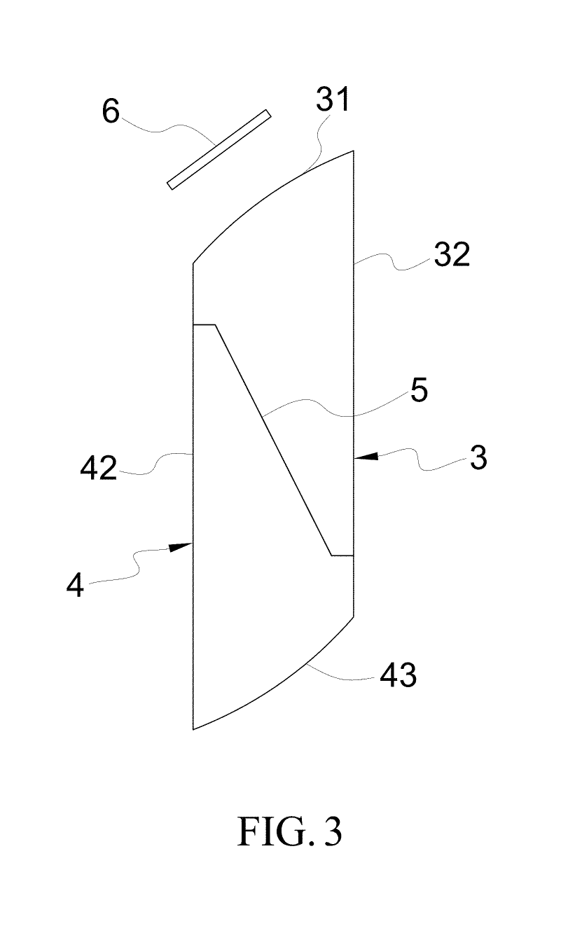

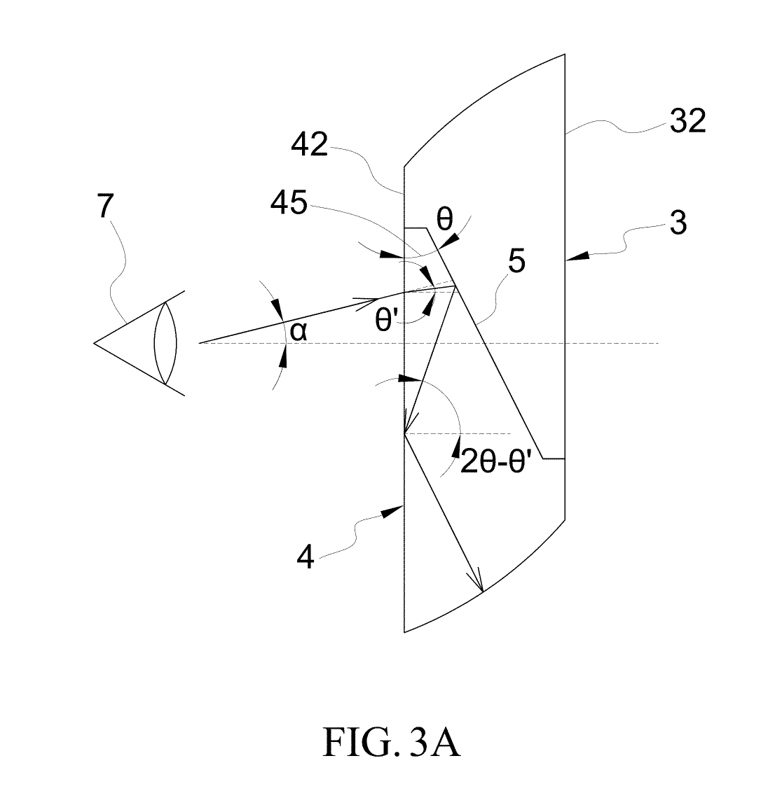

As shown in FIGS. 3 and 3A, according to optical principle, a half of the viewing angle (i.e., half angle of view) a perceived by a user's eye 7 is determined by the dimension of the display device 6 and the focal length of the see-through eyepiece. The half angle of view a is, therefore, a known number. As shown in FIG. 3A, the angle of inclination 45 of the partially reflective layer 5 (i.e., the included angle between the partially reflective layer 5 and the second total internal reflection surface 42) is θ. If light enters the second prism 4 from air through the second total internal reflection surface 42 at the half angle of view a, the light is refracted by a refraction angle θ′. The refracted light is then reflected by the partially reflective layer 5 and incident onto the second total internal reflection surface 42 at an incident angle 2θ−θ′ according to geometry. To achieve total internal reflection by the second total internal reflection surface 42, the incident angle 2θ−θ′ of the reflected light has to be greater than or equal to the critical angle θ_{c} for total internal reflection. As such, the angle of inclination 45 (θ) of the partially reflective layer 5 has to satisfy the following condition.

θ≥(θ_{c}+θ′)/2 where θ′ is the refraction angle of light passing through the second total internal reflection surface 42 from air, θ_{c} is the critical angle for total internal reflection. Further according to Snell's Law, θ′=arcsin(sin al n), and θ_{c}=arcsin(1/n), where n is the refractive index of the second prism 4. Therefore, compared to prior art, the thickness of the see-through eyepiece may be reduced by using smaller angle of inclination 45, as long as the foregoing condition is satisfied. If the see-through eyepiece of the present invention has a same thickness as that of the prior art, on the other hand, the present invention is able to achieve a greater viewing angle.

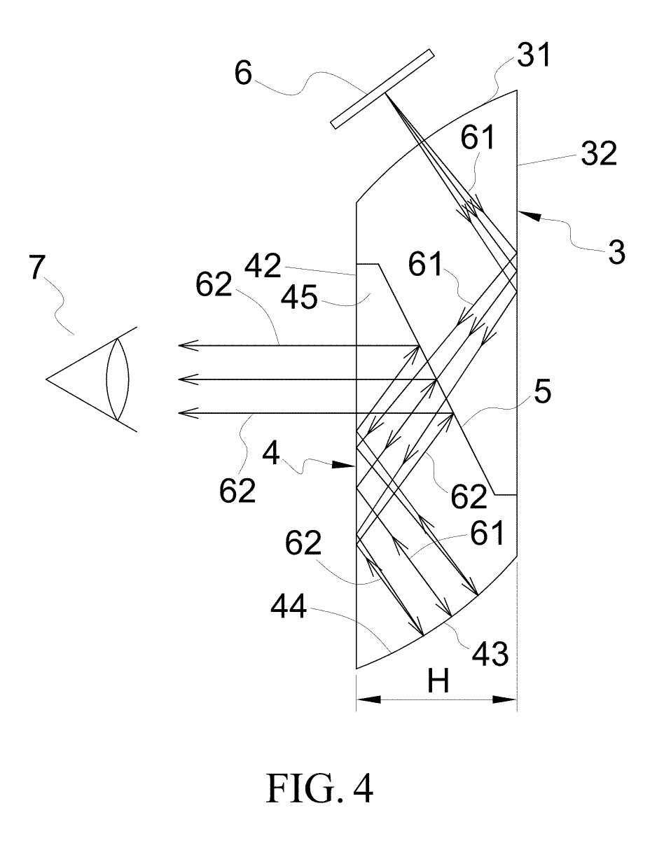

The operation of the present invention is described as follows. As shown in FIG. 4, display light 61 from the display device 6 may enter the first prism 3 through the input surface 31 and achieve total internal reflection from the first total internal reflection surface 32, as long as the display device 6 is tilted for a specific angle so that it is not parallel to the first total internal reflection surface 32. Display light 61 then passes through the partially reflection layer 5 and achieves total internal reflection from the second total internal reflection surface 42 of the second prism 4. Display light 61 is then reflected by the concave mirror formed by the reflection surface 43 and the reflection layer 44. The display light 61 finally reaches the user's eye 7, superimposed with the external scene, after undergoing the total internal reflection by the second total internal reflection surface 42 and the reflection by the partially reflective layer 5.

As illustrated in FIGS. 1 and 4, the see-through eyepiece of the present invention is structurally simple and is, therefore, ideal for mass production. By appropriately configuring the angle of inclination 45, image from the display device 6 may be conveniently integrated by total internal reflection. Compared to the prior art, under a same field or angle of view (FOV or AOV), the see-through eyepiece of the present invention may effectively reduce the thickness H of the see-through eyepiece or, under the same thickness, may achieve a greater FOV or AOV. The see-through eyepiece of the present invention, therefore, has a superior performance and applicability.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A see-through eyepiece, comprising a first prism, a second prism, and a partially reflective layer, wherein
the first prism has an input surface for receiving light from a display device in entering the first prism, a flat first total internal reflection surface, and a first interface surface;
the second prism has a second interface surface, a flat second total internal reflection surface, and a reflection surface coated with a reflection layer;
the partially reflective layer is disposed between the second interface surface of the second prism and the first interface surface of the first prism; and
the second and first prisms are attached together along the second and first interface surfaces, thereby forming the complete see-through eyepiece with the first total internal reflection surface and the second total internal reflection surface positioned in parallel on two opposite sides of the see-through eyepiece, and the input surface and the reflection surface also positioned in parallel on another two opposite sides of the see-through eyepiece.

2. The see-through eyepiece according to claim 1, wherein the input surface is a curved or aspheric surface; the input surface is carved with binary diffi active optical elements (DOEs); and the reflection surface is a curved or aspheric surface.

3. The see-through eyepiece according to claim 1, wherein the partially reflective layer is a beam splitter.

4. The see-through eyepiece according to claim 1, wherein the reflection layer is an aluminum or silver layer.

5. The see-through eyepiece according to claim 1, wherein the angle of inclination θ of the partially reflective layer satisfies the conditions: θ≥(θ_{c}+θ′)/2, θ′=arcsin(sin α/n), and θ_{c}=arcsin(1/n), where θ′ is the refraction angle of light passing through the second total internal reflection surface from air, θ_{c} is the critical angle for total internal reflection, a is the half angle of view, n is the refractive index of the second prism.
